(19) United States
(12) Patent Application Publication
(10) Pub. No.: US 2025/0107524 A1
(43) Pub. Date: Apr. 3, 2025

(54) Single Dose Disinfectant

(71) Applicant: ARXADA AG, Visp (CH)

(72) Inventors: Marcus Bentley, Monroe Township, NJ (US); Xunan Zhu, Livingston, NJ (US); Xiao Jiang, Montvale, NJ (US)

(21) Appl. No.: 18/834,259

(22) PCT Filed: May 4, 2023
(86) PCT No.: PCT/US2023/020993

§ 371 Date: Jul. 30, 2024

Related U.S. Application Data
(60) Provisional application No. 63/340,795, filed on May 11, 2022.

(51) Int. Cl. A01N 37/36; A01N 25/04; A01N 25/30; A01P 1/00

(52) U.S. Cl. CPC A01N 37/36; A01N 25/04; A01N 25/30; A01P 1/00

(57) ABSTRACT

Generally, the present disclosure is directed to single dose, or unitary disinfecting concentrates that are stable in a dissolvable container. The disinfecting concentrate includes at least one biodegradable carboxylic acid and at least one anionic surfactant, and is stable for at least one week at 54° C. as measured according to EPA storage stability test protocol (830.6317). While exhibiting good stability, the disinfecting concentrate is also able to dissolve quickly in water, and, once diluted, exhibits a micro efficacy against Pseudomonas aeruginosa, Staphylococcus aureus, or both Pseudomonas aeruginosa, Staphylococcus aureus at 3 minute contact time according to the Germicidal Spray Test method AOAC 961.02.

### RELATED APPLICATIONS

The present application is based on and claims priority to U.S. Provisional Application Ser. No. 63/340,795 filed on May 11, 2022 which are incorporated herein by reference.

### BACKGROUND

Sanitization and/or disinfection is required in many industries including in the homes of consumers, because of both regulatory and safety concerns. Disinfectant formulations have been developed over the last several decades to reduce or destroy pathogenic organisms such as bacteria, fungi, and viruses. There has been a particular focus on hard surfaces, including floors, walls, countertops, windows, windowsills, sinks, faucets, waste containers, appliances, and cabinet surfaces, as any hard surface can become contaminated, and are often used for food preparation or medical services. Disinfectants have been developed to treat hard surfaces for use in hospitals, rest homes, schools, and homes, however, due to the active ingredients contained in such disinfectants, they are generally packaged in single use, non-biodegradable plastic bottles.

Many different types of sanitizing and/or disinfecting agents have been suggested in the past in formulating disinfectants. For instance, such sanitizing and/or disinfecting agents have included alcohols, chlorine compounds, glutaraldehyde, hydrogen peroxide, iodophors, peracetic acid, phenolics, and quaternary ammonium compounds. However, many of these known sanitizing and/or disinfecting agents, such as quaternary ammonium compounds and halogenated compounds fail to meet current sustainability standards.

Nonetheless, in order to facilitate application, increase the range of activity against different types of microorganisms, or otherwise increase efficacy, the above anti-microbial agents have been used at high concentrations and/or in combination with many other agents, ingredients and components. However, due to the high concentrations necessary to achieve a sanitizing and/or disinfecting composition, and particularly, a concentrate thereof, sanitizing and/or disinfecting agents have proven difficult to stabilize in soluble packaging, such as water-soluble films as well as sachets and/or pods made therefrom. For instance, due to the nature of the sanitizing and/or disinfecting agents, alone or in combination with their concentration, known disinfectant formulations cause the soluble packing to fail prior to meeting necessary shelf life stability, as the active ingredients are incompatible with the films utilized to form the dissolvable or soluble packaging, and begin hydrolysis of the film prior to contact with a solvent. In addition, unlike powdered, granule, or tablet formulations, as are known in the dishwasher and laundry industries, liquid disinfectants are further challenging in regards to stability, due to their increased contact area with the soluble film forming the packaging.

This poses serious problems for improving the sustainability of sanitizing and/or disinfecting products, as single-use packaging increases shipping and storage costs as well as the energy needed to transport the products. In addition, single-use plastic packaging is generally non-biodegradable, necessitating increased storage for disposal of the single-use packaging, as plastics cannot be degraded in the environment by living organisms. Further, current plastic packing, such as that made by polyethylene terephthalate, which is stable when in contact with known sanitizing and/or disinfecting agents, is not only non-biodegradable, but is also made from non-renewable fossil fuels.

Therefore, it would be a benefit to provide a sanitizing and/or disinfectant composition having improved sustainability. It would also be a benefit to provide a sanitizing and/or disinfectant composition suitable for use in reducing pathogenic organisms on hard surfaces. It would also be a benefit to provide a sanitizing and/or disinfectant composition contained in a solvent-dissolvable container. It would even be a further benefit to provide a sanitizing and/or disinfectant composition in concentrated form contained in a solvent-dissolvable container, such as a water-dissolvable or soluble container.

### SUMMARY

Generally, the present disclosure is directed to a disinfecting concentrate that includes a disinfectant liquid disposed in a compartment of biodegradable solvent-dissolvable container, which may also be referred to as a water-dissolvable or water-soluble container. The disinfectant liquid includes at least one biodegradable carboxylic acid, at least one anionic surfactant, where the at least one anionic surfactant is a sulfate based anionic surfactant, sulfonate based anionic surfactant, carboxylate based anionic surfactant, or a combination thereof, and optionally an alcohol solvent, where the at least one biodegradable carboxylic acid and the at least one anionic surfactant are present in the disinfectant concentrate of carboxylic acid to anionic surfactant of about 1:1 or greater on a weight to weight basis. Regardless of the total number of solvents present in the disinfectant liquid, the disinfecting liquid contains a total amount of solvents of up to about 50 wt. %. In addition, the biodegradable solvent-dissolvable container is stable for at least one week at 54° C. as measured according to EPA storage stability test protocol (830.6317). Furthermore, in an aspect, the biodegradable solvent-dissolvable container is stable for at least two weeks at 54° C. as measured according to EPA storage stability test protocol (830.6317).

In one aspect, the at least one biodegradable carboxylic acid is a C1-C10 carboxylic acid. Additionally or alternatively, in an aspect, the at least one biodegradable carboxylic acid is citric acid, sorbic acid, acetic acid, boric acid, formic acid, maleic acid, adipic acid, lactic acid, malic acid, malonic acid, glycolic acid, or mixtures thereof. In yet another aspect, the at least one biodegradable carboxylic acid is citric acid or lactic acid, and, in one aspect, the at least one biodegradable carboxylic acid is lactic acid.

Nonetheless, in another aspect, the anionic surfactant is a C11-C18 alkyl benzene sulfonate, a C10-C20 branched-chain alkyl sulfate, a C10-C18 alkyl ethoxy sulfate, a mid-chain branched alkyl sulfate, a mid-chain branched alkyl alkoxy sulfate, a C10-C18 alkyl alkoxy carboxylate containing 1-5 ethoxy units, a modified alkylbenzene sulfonate, a C12-C20 methyl ester sulfonate, a C10-C18 alpha-olefin sulfonate, a C6-C20 sulfosuccinate, a fatty methyl ester sulphonate, an alkyl ethyoxy sulphates, an alkyl polyalkoxylated carboxylate, or mixtures thereof. Additionally or alternatively, in one aspect, the at least one anionic surfactant is a sulfate based anionic surfactant, sulfonate based anionic surfactant, or a combination thereof. In another aspect, the at least one anionic surfactant is sodium laureth sulfate, sodium cumenesulfonate, sodium dodecyl benzene sulfonate, sodium coco sulfate, ammonium coco sulfate, sodium lauryl glucoside hydroxypropyl sulfonate, ammonium lauryl glucoside hydroxypropyl sulfonate, sodium decyl glucoside hydroxypropyl sulfonate, ammonium decyl glucoside hydroxypropyl sulfonate or mixtures thereof. In yet a further aspect, the at least one biodegradable carboxylic acid and the at least one anionic surfactant are present in the disinfecting concentrate at a ratio of carboxylic acid to anionic surfactant from about 1:1.1 to about 1:50.

In one aspect, the biodegradable solvent-dissolvable container is formed from polyvinyl alcohol, a cellulose derivative, or combinations thereof.

Moreover, in an aspect, the disinfecting concentrate further includes one or more nonionic surfactants, one or more cationic surfactants, a second anionic surfactant, or a combination thereof. In a further aspect, the disinfecting concentrate further includes a saturated fatty acid, such as caprylic acid, capric acid, lauric acid, myristic acid, palmitic acid, stearic acid, arachidic acid, behenic acid, lignoceric acid, cerotic acid, oleic acid, decaoleic acid, and mixtures thereof, and/or can be, in one aspect, be a polyglyceryl fatty ester, such as one or more of a polyglyceryl-10 laurate, polyglyceryl-10 decaoleate; polyglyceryl-3 monostearate; polyglyceryl-6 distearate, polyglyceryl-10 stearate; polyglyceryl-10 oleate; polyglyceryl-10 dipalmitate, or polyglyceryl-10 caprylate/caprate. In a further aspect, the disinfecting concentrate can include the one or more nonionic surfactants, where the one or more nonionic surfactants can include an alcohol ethoxylate.

The disinfecting concentrate can also, in one aspect, include a non-aqueous solvent, such as glycerin, glycol, propanediol, butanediol, glycerol, diethylene glycol, dipropylene glycol, dibutylene glycol, hexylene glycol, glycol ether, such as ethylene glycol methyl ether, ethylene glycol ethyl ether, ethylene glycol propyl ether, ethylene glycol mono-n-butyl ether, diethylene glycol methyl ether, diethylene glycol ethyl ether, diethylene glycol mono butyl ether, propylene glycol methyl, ethyl, or propyl ether, dipropylene glycol monomethyl or ethyl ether, diisopropylene glycol monomethyl or ethyl ether, methoxy-, ethoxy-, or butoxytriglycol, 1-butoxyethoxy-2-propanol, 3-methyl-3-methoxybutanol, propylene glycol t-butyl ether, or mixtures thereof. In an aspect, the disinfecting concentrate includes the alcohol solvent, where the alcohol solvent is methanol, ethanol, propanol, isopropanol, butanol, or combinations thereof. Furthermore, in an aspect, the disinfecting concentrate can further include a humectant, a chelating agent, or a combination thereof. Additionally or alternatively, in an aspect, the pH of the disinfectant liquid is less than about 7, preferably from about 1 to about 6, even more preferably from about 1.5 to about 5

The present disclosure is also generally directed to a disinfectant solution that includes any one or more of the above aspects of a disinfecting concentrate and a diluent. In one aspect, the disinfecting concentrate is diluted with the diluent at a ratio of disinfecting concentrate to diluent of about 1:8 or greater, preferably from about 1:10 to about 1:100. Additionally or alternatively, in an aspect, the disinfectant solution has a pH of less than 7. Furthermore, in one aspect, the disinfecting solution exhibits a micro efficacy against Pseudomonas aeruginosa and Staphylococcus aureus at 3 minute contact time according to the Germicidal Spray Test method AOAC 961.02. In yet a further aspect, the disinfecting concentrate exhibits a dilution time of about 3 minutes or less.

Other features and aspects of the present disclosure are set forth in greater detail below, and it should be understood that any one or more of the above aspects can be utilized alone or in combination with any of the other aspects noted above or otherwise discussed herein.

### DEFINITIONS

As used herein, the terms “about,” “approximately,” or “generally,” when used to modify a value, indicates that the value can be raised or lowered by 10% and remain within the disclosed aspect, such as 7.5%, such as 5%, such as 4%, such as 3%, such as 2%, such as 1%, or any ranges or values therebetween. Moreover, the term “substantially free of” when used to describe the amount of substance in a material is not to be limited to entirely or completely free of and may correspond to a lack of any appreciable or detectable amount of the recited substance in the material. Thus, e.g., a material is “substantially free of” a substance when the amount of the substance in the material is less than the precision of an industry-accepted instrument or test for measuring the amount of the substance in the material. In certain example embodiments, a material may be “substantially free of” a substance when the amount of the substance in the material is less than 10%, less than 9%, less than 8%, less than 7%, less than 6%, less than 5%, less than 4%, less than 3%, less than 2%, less than 1%, less than 0.5%, or less than 0.1% by weight of the material.

As used herein, the terms “disinfect” and/or “sanitize” mean the reduction of contaminants and/or pathogenic organisms by about 90% or more, such as about 91% or more, such as about 92% or more, such as about 93% or more, such as about 94% or more, such as about 95% or more, such as about 96% or more, such as about 97% or more, such as about 98% or more, such as about 99% or more, or any ranges or values therebetween, within a 24 hour time period.

### DETAILED DESCRIPTION

It is to be understood by one of ordinary skill in the art that the present discussion is a description of exemplary embodiments only, and is not intended as limiting the broader aspects of the present disclosure

The present disclosure is generally directed to a unit-dose disinfecting concentrate with improved sustainability. Namely, the present disclosure has surprisingly found that a liquid disinfecting concentrate can be formed that is stable in a water-dissolvable film container, while still maintaining excellent disinfecting properties, by combining one or more biodegradable carboxylic acids with one or more anionic surfactants at a ratio of the one or more carboxylic acids to the one or more anionic surfactants of 1:1 or greater. In addition, as will be discussed in greater detail below, in some aspects, a further nonionic surfactant, one or more non-aqueous solvents, a saturated fatty acid, or a combination thereof, can further contribute stability to the disinfecting concentrate according to the present disclosure.

For instance, the disinfecting liquid of the present disclosure is stable in the solvent-dissolvable carrier (such as a polyvinyl alcohol pouch or pod as will be discussed in greater detail below) for at least about 1 day at 54° C. as measured according to EPA storage stability test protocol (830.6317), such as about 3 days or more, such as about one week or more, such as about ten days or more, such as about two weeks or more, tested at 54° C. and as measured according to EPA storage stability test protocol (830.6317). Thus, unlike previous disinfecting concentrates, the composition of the present disclosure exhibits the necessary stability to be contained in a soluble or dissolvable pod to be considered to be shelf-stable. Thus, the disinfecting concentrate of the present disclosure reduces non-biodegradable packaging and provides a unit dose concentrate than can be added to a solvent/diluent to form a ready-to-use disinfecting solution by an end user.

While displaying excellent stability, the compositions according to the present disclosure also exhibit excellent dilution times, which is the time at which a homogenous or fully dissolved solution, meaning the time at which no visible particles remain in the solution, is obtained from the disinfecting concentrate diluted with a diluent, such as water, of about 30 minutes or less, such as about 20 minutes or less, such as about 15 minutes or less, such as about 10 minutes or less, such as about 5 minutes or less, such as about 4 minutes or less, when dissolved in OECD hard water (375 ppm based upon CaCO3 concentration). Thus, while the disinfecting concentrate exhibits greatly improved stability, the anionic surfactant(s) still allow the one or more carboxylic acids to interact with the diluent to quickly break down the solvent-dissolvable container when placed in a solvent in which the film is soluble, such as water.

In addition, as noted above, it was surprisingly found that, when any one or more of the above disinfecting concentrates are diluted with a diluent, such as water, the disinfecting solution, in addition to the above reduction of pathogenic organisms or contaminants, can exhibit a micro efficacy against Pseudomonas aeruginosa, Staphylococcus aureus, or both Pseudomonas aeruginosa and Staphylococcus aureus at a 60 minute contact time or less according to the Germicidal Spray Test method AOAC 961.02, such as about 45 minutes or less, such as about 30 minutes or less, such as about 15 minutes or less, such as about 10 minutes or less, such as about 8 minutes or less, such as about 7.5 minutes or less, such as about a 5 minute or less contact time according to the Germicidal Spray Test method AOAC 961.02.

Nonetheless, as noted above, the disinfecting concentrate is formed from a disinfecting liquid that includes at least one biodegradable carboxylic acid. While one having skill in the art may understand that other biodegradable carboxylic acids having disinfecting properties can be used, in one aspect, the carboxylic acid is a C1-C10 carboxylic acid, such as citric acid, sorbic acid, acetic acid, boric acid, formic acid, maleic acid, adipic acid, lactic acid, malic acid, malonic acid, glycolic acid, or mixtures thereof. In one aspect, the at least one biodegradable carboxylic acid is citric acid, lactic acid, or a combination thereof, and, in one aspect, the at least one biodegradable carboxylic acid is lactic acid. It should be understood that, in an aspect, any two or more of the above biodegradable carboxylic acids are utilized in the disinfecting liquid. However, in an aspect, the disinfecting liquid only contains a single acid, such as, in one aspect, lactic acid.

Regardless of the carboxylic acid(s) selected, the one or more biodegradable carboxylic acid(s) may be present in the concentrate in an amount from about 1% to about 30% by weight, such as about 1.5% to about 15% by weight such as about 2% to about 14%, such as about 3% to about 13%, such as about 4% to about 12%, such as about 5% to about 10%, or any ranges or values therebetween. Nonetheless, as will be discussed in greater detail below, the one or more carboxylic acids are present in an amount sufficient to provide the disinfecting properties discussed above.

Surprisingly, a disinfecting concentrate formulated in accordance with the present disclosure can be essentially free or completely free of quaternary ammonium compounds, as well as other non-biodegradable disinfecting agents, including halogenated compounds, such as sodium hypochlorite, and biocidal metals. As used herein, a quaternary ammonium compound is defined as a nitrogen bonded to 4 groups, where none of the groups is an oxygen. For example, a quaternary ammonium compound can be bonded to four groups that are independently alkyl or aromatic carbon chains. The carbon chains can be substituted with a halogen, an alcohol, or other chemical groups; however, the carbon chains should not include another ionizable group (i.e., the quaternary ammonium group is the sole ionizable group). However, these compounds are not biodegradable, and also lead to failure of the solvent-dissolvable container without reaching necessary shelf-life.

Nonetheless, in one aspect, the disinfecting concentrate according to the present disclosure may not include any other disinfecting actives other than the one or more biodegradable carboxylic acid(s).

Regardless of the one or more biodegradable carboxylic acids selected, the disinfectant liquid also includes one or more anionic surfactants. In one aspect, the anionic surfactant is a C11-C18 alkyl benzene sulfonate, a C8-C20 straight or branched-chain alkyl sulfate, a C8-C18 alkyl ethoxy sulfate, a mid-chain branched alkyl sulfate, a mid-chain branched alkyl alkoxy sulfate, a C8-C18 alkyl alkoxy carboxylate containing 1-5 ethoxy units, a modified alkylbenzene sulfonate, a C12-C20 methyl ester sulfonate, a C10-C18 alpha-olefin sulfonate, a C6-C20 sulfosuccinate, a fatty methyl ester sulphonate, an alkyl ethyoxy sulphate, an alkyl polyalkoxylated carboxylate, or mixtures thereof. Furthermore, in one aspect, the at least one anionic surfactant is a sulfate based anionic surfactant, sulfonate based anionic surfactant, or a combination thereof.

In one aspect, the at least one anionic surfactant is sodium laureth sulfate, sodium lauryl sulfate, sodium cumenesulfonate, sodium dodecyl benzene sulfonate, sodium coco sulfate, sodium octyl sulfate, ammonium coco sulfate, sodium lauryl glucoside hydroxypropyl sulfonate, ammonium lauryl glucoside hydroxypropyl sulfonate, sodium decyl glucoside hydroxypropyl sulfonate, ammonium decyl glucoside hydroxypropyl sulfonate or mixtures thereof. While any one or more of the above anionic surfactants may be used in accordance with the present disclosure, in an aspect, the one or more anionic surfactants includes a blend of two or more sulfate based anionic surfactants, two or more sulfonate based anionic surfactants, or a combination of a sulfate and sulfonate based anionic surfactant.

Regardless of the one or more anionic surfactant(s) selected, the one or more anionic surfactant(s) can be present in the concentrate in an amount from about 1% to about 90% by weight, such as about 1.5% to about 80% by weight, such as about 2% to 70% by weight, such as about 2.5% to about 60% by weight, such as about 3% to about 50% by weight, such as about 3.5% to about 40%, such as about 4% to about 20%, such as about 4.5% to about 17%, such as about 5% to about 16%, or any ranges or values therebetween. In one aspect, if more than one anionic surfactant is present, each of the anionic surfactants may be present according to any one or more of the above weight percentages. However, in an aspect, it should be understood that the above weight percentages encompass all of the anionic surfactants present in the concentrate.

However, as noted above, it should be understood that the present disclosure is directed to a disinfectant/sanitizing agent. Therefore, in one aspect, the one or more anionic surfactants are selected to have little to no foaming properties, unlike anionic surfactants selected for soaps, detergents, and other foaming personal care applications. In addition, in one aspect, the anionic surfactant does not include substantially any acids, and, in an aspect, is free of acids of anionic surfactants.

Notwithstanding the amount of the one or more anionic surfactant(s) and biodegradable carboxylic acid(s) contained in the disinfecting concentrate, as noted above, the present disclosure has surprisingly found that by carefully controlling the ratio of the at least one biodegradable carboxylic acid and the at least one anionic surfactant, a concentrate with improved stability can be formulated. Thus, in one aspect, the at least one biodegradable carboxylic acid and the at least one anionic surfactant are present in the disinfecting concentrate at a ratio of carboxylic acid to anionic surfactant of about 1:1 or greater, such as about 1:1.1 or greater, such as about 1:1.2 or greater, such as about 1:1.3 or greater, such as about 1:1.4 or greater, such as about 1:1.5 or greater up to about 1:50 or less, such as about 1:45 or less, such as about 1:40 or less, such as about 1:30 or less, such as about 1:25 or less, such as about 1:20 or less, such as about 1:15 or less, such as about 1:10 or less, or any ranges or values therebetween.

Moreover, as noted above, in one aspect, the present disclosure has surprisingly found that including one or more nonionic surfactants, one or more non-aqueous solvents, and/or one or more fatty acids may further improve the stability of the disinfectant concentrate. For instance, without wishing to be bound by theory, while the one or more anionic surfactants stabilize the one or more biodegradable carboxylic acids, some of the acid may still be capable of hydrolyzing and cross-linking with the solvent-soluble container. Thus, in one aspect, one or more nonionic surfactants, one or more non-aqueous solvents, and/or one or more fatty acids can be used to additionally stabilize the one or more carboxylic acids to further prevent hydrolyzing and cross-linking with the solvent-dissolvable container.

Thus, in one aspect, the disinfectant concentrate also includes one or more nonionic surfactants, such as alkoxylated alcohols, fatty alcohols, glycol ethers, alkyl polyglucosides, phenol ethers, glycerol esters, fatty acid esters, amine oxides, alkylene glycols, and combinations thereof. For instance, in one aspect, the nonionic surfactant can include a polyoxyethylene glycol alkyl ether, an octaethylene glycol monododecyl ether, a pentaethylene glycol monododecyl ether, a polyoxypropylene glycol alkyl ether, an alkyl polyglucoside, glucoside alkyl ethers, decyl glucoside, lauryl glucoside, octyl glucoside, a polyoxyethylene glycol octylphenol ether, a polyoxyethylene glycol alkylphenol ether, a glycerol alkyl ester, a polyglycerol ester, glyceryl laurate, a polyoxyethylene glycol sorbitan alkyl ester, a sorbitan alkyl ester, dodecyldimethylamine oxide, block copolymers of polyethylene glycol and polypropylene glycol, poloxamers and polyethoxylated tallow amine (POEA), and mixtures thereof, preferably, in one aspect, at least one of the nonionic surfactants is an alcohol ethoxylate.

When present, the one or more nonionic surfactants can be present in the disinfecting concentrate in an amount of about 50% or less by weight of the disinfecting concentrate, such as about 49% or less, such as about 48% or less, such as about 47% or less, such as about 46% or less, such as about 45% or less, such as about 40% or less, such as about 35% or less, such as about 1% or more, such as about 5% or more, such as about 10% or more, such as about 15% or more, such as about 20% or more, or any ranges or values therebetween.

Furthermore, as noted above, the disinfecting concentrate of the present disclosure can also include a saturated fatty acid. In one aspect, the saturated fatty acid is a medium chain saturated fatty acid, such as caprylic acid, capric acid, lauric acid, myristic acid, palmitic acid, stearic acid, arachidic acid, behenic acid, lignoceric acid, cerotic acid, oleic acid, decaoleic acid, and mixtures thereof.

When present, the one or more saturated fatty acids can be present in the disinfecting concentrate in an amount of from about 1% to about 30% by weight, such as about 1.5% to about 20% by weight, such as about 2% to about 19%, such as about 3% to about 18%, such as about 4% to about 17%, such as about 5% to about 16%, or any ranges or values therebetween.

Additionally, as briefly mentioned above, the disinfecting concentrate of the present disclosure can also include one or more non-aqueous solvents. In one aspect, the non-aqueous solvent is still water-miscible, so as to aid in dissolution upon dilution of the disinfectant concentrate. Thus, in an aspect, the non-aqueous solvent can be an alcohol, a glycol ether, a glycol, or a combination thereof.

For instance, in one aspect, the non-aqueous solvent can be an organic alcohol solvent, such as methanol, ethanol, propanol, isopropanol, butanol, benzyl alcohol, such as 1-butoxyethoxy-2-propanol, 3-methyl-3-methoxybutanol or combinations thereof.

Additionally or alternatively, the non-aqueous solvent can be a glycol or glycol ether solvent, such as diethylene glycol propyl ether, ethylene glycol methyl ether, ethylene glycol ethyl ether, ethylene glycol propyl ether, ethylene glycol mono-n-butyl ether, diethylene glycol methyl ether, diethylene glycol ethyl ether, diethylene glycol mono butyl ether, propylene glycol methyl, ethyl, or propyl ether, dipropylene glycol monomethyl or ethyl ether, diisopropylene glycol monomethyl or ethyl ether, ethyl ether, methoxy-, ethoxy-, or butoxytriglycol, propylene glycol t-butyl ether, ethylene glycol monomethyl ether, ethylene glycol monoethyl ether, ethylene glycol monopropyl ether, ethylene glycol monoisopropyl ether, ethylene glycol monobutyl ether, diethylene glycol monomethyl ether, diethylene glycol monobutyl ether, diethylene glycol monoethyl ether, diethylene glycol mono-n-butyl ether, ethylene glycol dimethyl ether, ethylene glycol diethyl ether, ethylene glycol dibutyl ether, propylene glycol n-butyl ether, tripropylene glycol methyl ether, dipropylene glycol methyl ether, dipropylene glycol butyl ether, glycerol, ethylene glycol, diethylene glycol, dipropylene glycol, dibutylene glycol, polyethylene glycol, propylene glycol, dipropylene glycol, hexylene glycol, butylene glycol (1,3-butyleneglycol, 1,2-butyleneglycol, 1,4-butyleneglycol), propylene glycol monocaprylate, and polyethylene glycol caprylate or combinations thereof.

The nonaqueous solvent, in an aspect, can also be a diol, such as a propanediol or a butanediol, or combinations of any two or more of the above organic alcohols, diols, glycols, or glycol ethers. In one aspect, the glycols, glycol ethers, diols, or organic alcohols can include hexylene glycol, isopropyl alcohol, a glycol ether, a glycerol, or a combination thereof.

When present, the one or more solvents can be present in the disinfecting concentrate in an amount of about 50% or less by weight of the disinfecting concentrate, such as about 49% or less, such as about 48% or less, such as about 47% or less, such as about 46% or less, such as about 45% or less, such as about 40% or less, such as about 35% or less, such as about 1% or more, such as about 5% or more, such as about 10% or more, such as about 15% or more, such as about 20% or more, or any ranges or values therebetween. Of course, as noted above, the weight ratios may refer to the organic alcohol alone, the glycol ether alone, or may instead refer to a total weight of all of the solvents contained in the disinfecting concentrate.

Regardless of the at least one biodegradable carboxylic acid and the at least one anionic surfactant selected, the disinfectant concentrate can include one or more surfactants, fillers, humectants, such as glycerin, chelating agents, and other inert ingredients, such as fragrances, dyes, dispersants, stabilizers, and the like, so long as they do not act to hydrolyze or destabilize the solvent-dissolvable container.

The disinfectant concentrate can also include one or more non-quaternary ammonium (quat) cationic surfactants. For instance, in one aspect, the non-quaternary ammonium cationic surfactant is a primary, secondary, and/or tertiary amine, such as one or more C8-C22 primary, secondary, and/or tertiary amines.

When present, the one or more cationic surfactant(s) can be present in the disinfecting concentrate in an amount of about 10% or less by weight of the disinfecting concentrate, such as about 9% or less, such as about 8% or less, such as about 7% or less, such as about 6% or less, such as about 5% or less, such as about 4% or less, such as about 3% or less, such as about 2% or less, such as about 1% or more, or any ranges or values therebetween.

The disinfectant concentrate can also include one or more fillers. Fillers utilized in the disinfecting concentrate can include inorganic salts of sulfate, carbonate, and chloride anions. In one aspect, fillers can include lithium, sodium, potassium, magnesium and calcium salts of sulfate, carbonate, and chloride anions.

When present, the one or more fillers can be present in the disinfecting concentrate in an amount of about 10% or less by weight of the disinfecting concentrate, such as about 9% or less, such as about 8% or less, such as about 7% or less, such as about 6% or less, such as about 5% or less, such as about 4% or less, such as about 3% or less, such as about 2% or less, such as about 1% or more, or any ranges or values therebetween.

Surprisingly, the present disclosure has found that the disinfectant liquid has an acidic pH of about 7 or less, such as about 6.5 or less, such as about 6 or less, such as about 5.5 or less, such as about 5 or less, such as about 4.5 or less, such as about 4 or less, such as about 1.5 or greater, or any ranges or values therebetween. Namely, without wishing to be bound by theory, it was found that by maintaining an acidic pH, the disinfecting properties of the disinfecting solution may be further improved while still maintaining the stability of the disinfecting concentrate in the solvent-dissolvable container

Notwithstanding the final formulation of the disinfecting liquid, the disinfectant liquid of the present disclosure is disposed within a solvent-dissolvable container. In one aspect, the solvent dissolvable container(s) containing the disinfecting liquid concentrate do not require further individual packaging due to the improved stability of the concentrate of the present disclosure. Nonetheless, in one aspect, two or more of the solvent-dissolvable containers of the present disclosure may be disposed in packaging that prevents premature contact with the disinfecting concentrate and water, such as an overpack container as known in the art. However, as noted, it should be understood that such a packaging contains a plurality of the solvent-dissolvable containers of the present disclosure, and does not include non-dissolvable packaging for each unit-dose.

Nonetheless, in one aspect, the solvent-dissolvable container is formed from one or more films formed of: a polyvinyl alcohol (PVA), a polyalkylene oxide, a cellulose or derivative thereof, a cellulose ether, a cellulose ester, a cellulose amide, a polyvinyl acetate, polysaccharides, including starch and gelatin, natural gums such as xanthum and carragum, glycerine, chitosan, a modified starch, and combinations thereof. In one aspect, the biodegradable solvent-dissolvable container is formed from polyvinyl alcohol, a cellulose derivative, or a combination thereof.

In one aspect, the solvent-dissolvable container contains a polyvinyl alcohol in an amount of at least 60% by weight of the container (prior to the inclusion of the disinfectant liquid), such as about 70% or more, such as about 80% or more, such as about 90% or more, such as up to 100% by weight based upon the weight of the empty container. In one aspect, the film is crosslinked to increase strength and flexibility of the film. However, as noted above, crosslinking and any other additives should maintain the biodegradability of the solvent-dissolvable container, and should not slow hinder the dissolution of the disinfecting concentrate once submerged in a solvent, such as water.

After formation of the water-soluble film, the disinfecting liquid may be prepared by preparing the disinfectant liquid, and sealing a portion of the disinfectant liquid within a container, such as a pouch, pod, or packet formed by a water soluble film as discussed above, such as a polyvinyl alcohol film or other biodegradable water soluble polymer film. Preparing the disinfectant liquid may include combining one or more of the components of the concentrated disinfecting liquid, and mixing the combined components to produce a disinfectant liquid. The container(s) containing the disinfectant liquid are then sealed by any known machine and/or technique.

Each of the unit dose disinfecting concentrate(s) can include an amount of active ingredient sufficient to yield the above discussed disinfecting properties in combination with an amount of anionic surfactant(s) sufficient to stabilizing the one or more biodegradable carboxylic acids. Thus, as one having skill in the art would understand that various amounts may be used based upon the final dilution to yield final concentrations of 100 ppm to about 10,000 ppm of the active upon dilution, such as about 250 ppm to about 8,000 ppm, such as about 500 ppm to about 6,000 ppm, such as about 750 ppm to about 4,000 ppm, such as about 1,000 ppm to about 3,000 ppm, or any ranges or values therebetween.

Moreover, in one aspect, each disinfecting concentrate unit dosage can contain from about 2 grams to about 60 grams of the disinfecting liquid, such as from about 3 grams to about 45 grams, such as about 4 grams to about 40 grams, or any values or ranges therebetween. While the unit dosage containers can be formed into a variety of shapes and sizes, in one aspect, the unit dosage container can have a generally square or rectangular cross-section, or instead may be formed as a long cylindrical cross section in order to facilitate use with bottle.

As discussed above, the disinfecting concentrate according to the present disclosure is a unit dosage, meaning that each water-dissolvable container contains an amount of the disinfecting liquid sufficient to provide the above disinfecting/sanitizing effects when diluted with water or another suitable solvent. In one aspect, each water-dissolvable container can be diluted with a diluent at a ratio of the disinfecting concentrate to diluent of about 1:8 or greater, such as about 1:9 or greater, such as about 1:10 or greater, such as about 1:11 or greater, such as about 1:12 or greater, such as about 1:13 or greater, such as about 1:14 or greater, up to about 1:100 or less, such as about 1:90 or less, such as about 1:80 or less, such as about 1:70 or less, or any ranges or values therebetween.

Once diluted, the disinfecting solution has an acidic pH of about 7 or less, such as about 6.5 or less, such as about 6 or less, such as about 5.5 or less, such as about 5 or less, such as about 4.5 or less, such as about 4 or less, such as about 1.5 or greater, or any ranges or values therebetween. Namely, without wishing to be bound by theory, it was found that by maintaining an acidic pH, the disinfecting properties of the disinfecting solution may be further improved while still maintaining the stability of the disinfecting concentrate in the solvent-dissolvable container.

Nonetheless, the present disclosure is also generally directed to disinfecting and/or sanitizing a hard surface and/or to clean and/or sterilize instruments. Thus, in one aspect, the disinfectant solution (e.g. after dilution of the disinfecting concentrate) can be delivered to a surface to be cleaned, sanitized or disinfected by conventional methods, such as pouring the composition on a surface; spraying the surface, including but not limited to, pump spray applicators, pressurized spray applicators and the like; a saturated wipe; a rag and a bucket; a mop and bucket; a sponge and a bucket; or via automated cleaning equipment and other similar and conventional ways to apply an anti-microbial or disinfectant composition to a surface for the purposes of sanitizing or disinfecting the surface.

To use the disinfectant solution of the present disclosure, a surface is treated with the substrate by spraying, pouring, wiping, or otherwise applying the disinfecting solution to the surface. Once applied to the surface, the disinfecting solution is allowed to remain on the surface for a period of time. The disinfectant composition may be applied to the surface and allowed to dry or may alternatively be dried by wiping the surface with a dry wipe or wiping device.

Surfaces, which may be disinfected with the disinfectant composition include, but are not limited to, those located in dairies, homes, health care facilities, swimming pools, canneries, food processing plants, restaurants, hospitals, institutions, and industry, including secondary oil recovery. Any suitable hard surface may be treated in accordance with the present disclosure, particularly frequently touched hard surfaces. The hard surface, for instance, can be made from glass, a metal such as an aluminum or stainless steel, a ceramic, a stone such as granite or marble, a plastic or polymer material, or the like. Specific areas targeted for application include hard surfaces in the home such as kitchen countertops, cabinets, appliances, waste cans, laundry areas, garbage pails, bathroom fixtures, toilets, water tanks, faucets, mirrors, vanities, tubs, and showers. The compositions can also be used to sanitize floors, walls, furniture, mirrors, toilet fixtures, windows, and wood surfaces, such as fence rails, porch rails, decks, roofing, siding, window frames, and door frames. The compositions are particularly well suited for application on indirect food contact surfaces, such as cutting boards, utensils, containers, dishes, wash basins, appliances, and countertops. Areas in hospitals would include beds, gurneys, tables, canisters, toilets, waste cans, stands, cabinets, shower stalls, floors, door knobs, bed rails, walls or any other non-porous surface. Particularly, in one aspect, the surface can be an inanimate, non-porous, hard surface in any location.

The following examples are intended to provide a more complete understanding of the present disclosure. The examples are not intended, however, to limit the disclosure.

### Example 1

Sample 1 was formed according to Table 1, and placed into a polyvinyl alcohol water-dissolvable container available from Aicello weighing approximately 0.8 grams (e.g. weight of the film prior to inclusion of the sample). Each polyvinyl alcohol water-dissolvable pouch contained approximately 30 g of sample.

TABLE 1

| | | Sample 1 |
|---|---|---|
| Ingredients | CAS# | % by wt. |
| Lactic Acid* | 79-33-4 | 7.58 |
| Isopropyl Alcohol | 67-63-0 | 4.00 |
| Sodium octyl sulfate ** | 142-31-4; 111-87-5 | 6.50 |
| Caprylic Acid | 124-07-2 | 12.00 |
| Alcohol ethoxylate*** | 64366-70-7 | 43.92 |
| Glycol ether**** | 112-34-5 | 10.00 |
| Hexylene Glycol | 107-41-5 | 8.00 |
| Glycerol | 56-81-5 | |
| Sodium Lauryl Sulfate | 151-21-3 | 8.00 |
| | | 100.00 |

*Available as PURAC ® Sanalic 88
** Available from Rhodapon OLS
***Available as Ecosurf EH-9
****Available as Butyl Carbitol

Sample 1 was tested for stability according to EPA storage stability test protocol (830.6317), the results of which are illustrated in Table 2 below. After one week and two week stability testing, samples were diluted in 32 ounces of water (e.g. one pod/pouch dissolved in 32 ounces of water) to form a ready-to-use disinfectant solution containing approximately 2,115 ppm active. The disinfectant solution was then tested against Staphylococcus aureus and Pseudomonas aeruginosa according to the Germicidal Spray Test method AOAC 961.02, the results of which are reproduced in Table 2 below.

TABLE 2

| | Sample 1 |
|---|---|
| Measurements | 30 g Pod |
| Dilution Time | 4 |
| Stability in PVOH FILM (1 wk. at 54° C.) | Film is dry, not wet or sticky |
| Stability in PVOH FILM (2 wk. at 54° C.) | Film is dry, not wet or sticky |
| Germicidal Spray* Products Test (5 min) | Passed Staph (0/60), |
| | Passed Pseudo (0/60) |

As illustrated in Table 2, the disinfecting concentrates according to the present disclosure exhibited excellent shelf stability while maintaining fast dissolution times. In addition, once diluted the disinfecting solutions also exhibited excellent control of Staphylococcus aureus and Pseudomonas aeruginosa according to the Germicidal Spray Test method AOAC 961.02.

These and other modifications and variations to the present invention may be practiced by those of ordinary skill in the art, without departing from the spirit and scope of the present invention, which is more particularly set forth in the appended claims. In addition, it should be understood that aspects of the various embodiments may be interchanged both in whole or in part. Furthermore, those of ordinary skill in the art will appreciate that the foregoing description is by way of example only, and is not intended to limit the invention so further described in such appended claims.

What is claimed:

1. A disinfecting concentrate comprising:
a disinfectant liquid disposed in a compartment of a biodegradable water-dissolvable container;
wherein the disinfectant liquid comprises
at least one biodegradable carboxylic acid,
at least one anionic surfactant, wherein the at least one anionic surfactant is a sulfate based anionic surfactant, sulfonate based anionic surfactant, carboxylate based anionic surfactant, or a combination thereof,
optionally, an alcohol solvent;
wherein the disinfecting liquid contains a total amount of solvents of up to about 50 wt. %,
wherein the at least one biodegradable carboxylic acid and the at least one anionic surfactant are present in the disinfectant concentrate of carboxylic acid to anionic surfactant of about 1:1 or greater on a weight to weight basis, and
wherein the biodegradable water-dissolvable container is stable for at least one week at 54° C. as measured according to EPA storage stability test protocol (830.6317).

2. The disinfecting concentrate of claim 1, wherein the at least one biodegradable carboxylic acid is a C₁-C₁₀ carboxylic acid.

3. The disinfecting concentrate of claim 1, wherein the at least one biodegradable carboxylic acid is citric acid, sorbic acid, acetic acid, boric acid, formic acid, maleic acid, adipic acid, lactic acid, malic acid, malonic acid, glycolic acid, or mixtures thereof.

4. The disinfecting concentrate of claim 1, wherein the at least one biodegradable carboxylic acid is citric acid or lactic acid.

5. The disinfecting concentrate of claim 1, wherein the at least one anionic surfactant is a C₁₁-C₁₈ alkyl benzene sulfonate, a straight or branched-chain alkyl sulfate, a C₁₀-C₁₈ alkyl ethoxy sulfate, a mid-chain branched alkyl sulfate, a mid-chain branched alkyl alkoxy sulfate, a C₁₀-C₁₈ alkyl alkoxy carboxylate containing 1-5 ethoxy units, a modified alkylbenzene sulfonate, a C₁₂-C₂₀ methyl ester sulfonate, a C₈-C₁₈ alpha-olefin sulfonate, a C₆-C₂₀ sulfosuccinate, a fatty methyl ester sulphonate, an alkyl ethyoxy sulphate, an alkyl polyalkoxylated carboxylate, or mixtures thereof.

6. The disinfecting concentrate of claim 1, wherein the at least one anionic surfactant is a sulfate based anionic surfactant, sulfonate based anionic surfactant, or a combination thereof.

7. The disinfecting concentrate of claim 1, wherein the at least one anionic surfactant is sodium laureth sulfate, sodium octyl sulfate, sodium cumenesulfonate, sodium dodecyl benzene sulfonate, sodium coco sulfate, ammonium coco sulfate, sodium lauryl glucoside hydroxypropyl sulfonate, ammonium lauryl glucoside hydroxypropyl sulfonate, sodium decyl glucoside hydroxypropyl sulfonate, ammonium decyl glucoside hydroxypropyl sulfonate, or mixtures thereof.

8. The disinfecting concentrate of claim 1, wherein the biodegradable water-dissolvable container is formed from polyvinyl alcohol, a cellulose derivative, or combinations thereof.

9. The disinfecting concentrate of claim 1, further comprising a saturated fatty acid, wherein the saturated fatty acid is caprylic acid, capric acid, lauric acid, myristic acid, palmitic acid, stearic acid, arachidic acid, behenic acid, lignoceric acid, cerotic acid, oleic acid, decaoleic acid, and mixtures thereof.

10. The disinfecting concentrate of claim 1, further comprising one or more nonionic surfactants, one or more cationic surfactants, a second anionic surfactant, or a combination thereof.

11. The disinfecting concentrate of claim 10, wherein the disinfecting concentrate includes the one or more nonionic surfactants, wherein the one or more nonionic surfactants is an alcohol ethoxylate.

12. The disinfecting concentrate of claim 1, further comprising a non-aqueous solvent, wherein the non-aqueous solvent is glycerin, glycol, propanediol, butanediol, glycerol, diethylene glycol, dipropylene glycol, dibutylene glycol, hexylene glycol, glycol ether, or mixtures thereof, optionally, wherein the non-aqueous solvent is ethylene glycol methyl ether, ethylene glycol ethyl ether, ethylene glycol propyl ether, ethylene glycol mono-n-butyl ether, diethylene glycol methyl ether, diethylene glycol ethyl ether, diethylene glycol mono butyl ether, propylene glycol methyl, ethyl, or propyl ether, dipropylene glycol monomethyl or ethyl ether, diisopropylene glycol monomethyl or ethyl ether, methoxy-, ethoxy-, or butoxytriglycol, 1-butoxyethoxy-2-propanol, 3-methyl-3-methoxybutanol, propylene glycol t-butyl ether, or mixtures thereof.

13. The disinfecting concentrate of claim 1, wherein the disinfecting concentrate includes the alcohol solvent, wherein the alcohol solvent is methanol, ethanol, propanol, isopropanol, butanol, or combinations thereof.

14. The disinfecting concentrate of claim 1, further comprising a humectant, a chelating agent, or a combination thereof.

15. The disinfecting concentrate of claim 1, wherein a pH of the disinfecting liquid is less than about 7.

16. The disinfecting concentrate of claim 1, wherein the biodegradable water-dissolvable container is stable for at least two weeks at 54° C. as measured according to EPA storage stability test protocol (830.6317).

17. A disinfecting solution comprising the disinfecting concentrate of claim 1 and a diluent.

18. The disinfecting solution of claim 17, wherein the disinfecting concentrate is diluted with the diluent at a ratio of disinfecting concentrate to diluent of about 1:8 or greater.

19. The disinfecting solution of claim 17, wherein the disinfecting solution exhibits a micro efficacy against Pseudomonas aeruginosa and Staphylococcus aureus at 3 minute contact time according to the Germicidal Spray Test method AOAC 961.02.

20. The disinfecting solution of claim 17, wherein the disinfecting concentrate exhibits a dilution time of about 3 minutes or less.
